(19) United States
(12) Patent Application Publication
(10) Pub. No.: US 2023/0254353 A1
(43) Pub. Date: Aug. 10, 2023

(54) Media streaming from source in online meeting screen-share

(71) Applicant: Microsoft Technology Licensing, LLC, Redmond, WA (US)

(72) Inventors: Vivek SHANKAR, Seattle, WA (US); David Pierre CLAUX, Redmond, WA (US)

(73) Assignee: Microsoft Technology Licensing, LLC, Redmond, WA (US)

(21) Appl. No.: 17/667,295

(22) Filed: Feb. 8, 2022

(51) Int. Cl. H04L 65/403; H04L 65/611; H04L 65/60; H04L 65/401

(52) U.S. Cl. CPC H04L 65/403; H04L 65/4076; H04L 65/60; H04L 65/4007

(57) ABSTRACT

A data processing system implements establishing a connection with an online communication platform using a first application to facilitate communication with the computing devices of participants to the online communication session, determining that presentation content includes embedded content comprising at least one embedded content item available from at least one content server, and obtaining embedded content information from a source of the presentation content on the data processing system. The embedded content information identifying the at least one embedded content item and a source information for each respective embedded content item, causing the presentation content and the embedded content information to be sent to the computing devices of the participants, and causing the presentation content and a representation of each respective embedded content item of the embedded content information and a control associated with each respective embedded content item to be displayed on the computing devices of the participants.

### BACKGROUND

Online meetings and other types of online communication sessions have become increasingly important. Many online communication platforms allow a presenter to share presentation content, such as but not limited to presentation slides, documents, web pages, and/or other such presentation content. The presentation content may include embedded streaming audio and/or video media sourced from a remote server and that is accessed and displayed on the computing device of the presenter and streamed to participants of the online meeting or other communication session. However, the audio and/or video quality of the streamed media is often poor at the computing devices of the participants, leading to a poor user experience. For at least these reasons, current approaches sharing embedded content during an online meeting or other online communication session have numerous shortcomings that significantly impact effectiveness of these approaches. Hence, there is a need for improved systems and methods that provide a technical solution for solving the technical problem of sharing online content during an online meeting or other online communication session.

### SUMMARY

An example data processing system according to the disclosure may include a processor and a machine-readable medium storing executable instructions. The instructions when executed cause the processor to perform operations including establishing a connection with an online communication platform using a first application to facilitate communication with a plurality of computing devices of participants to an online communication session. The operations include determining that presentation content being provided by the data processing system to the plurality of computing devices of participants to the online communication session includes embedded content. The embedded content includes at least one embedded content item available from at least one content server remote from the data processing system. The operations further include obtaining embedded content information from a source of the presentation content on the data processing system, the embedded content information identifying the at least one embedded content item and a source information for each respective embedded content item indicating the content server from which the respective embedded content item may be obtained, causing the presentation content and the embedded content information to be sent to the plurality of computing devices of the participants to the online communication session, causing the presentation content and a representation of each respective embedded content item of the embedded content information and a control associated with each respective embedded content item to be displayed on the plurality of computing devices of the participants. The control associated with a respective embedded content item, when activated, causes a respective computing device on which the control was activated to obtain the respective embedded content item from the source and present the respective content item on the respective computing device.

An example method implemented in a data processing system for sharing content in an online communication session includes establishing a connection with an online communication platform using a first application to facilitate communication with a plurality of computing devices of participants to the online communication session and determining that presentation content being provided by the data processing system to the plurality of computing devices of participants to the online communication session includes embedded content. The embedded content includes at least one embedded content item available from at least one content server remote from the data processing system. The method further includes obtaining embedded content information from a source of the presentation content on the data processing system. The embedded content information identifies the at least one embedded content item and a source information for each respective embedded content item indicating the content server from which the respective embedded content item may be obtained. The method further includes causing the presentation content and the embedded content information to be sent to the plurality of computing devices of the participants to the online communication session and causing the presentation content and a representation of each respective embedded content item of the embedded content information and a control associated with each respective embedded content item to be displayed on the plurality of computing devices of the participants. The control associated with a respective embedded content item, when activated, causes a respective computing device on which the control was activated to obtain the respective embedded content item from the source and present the respective content item on the respective computing device.

An example machine-readable medium bears stored instructions that, when executed by a processor of a programmable device, cause the processor to perform operations of establishing a connection with an online communication platform using a first application to facilitate communication with a plurality of computing devices of participants to an online communication session; determining that presentation content being provided by the data processing system to the plurality of computing devices of participants to the online communication session includes embedded content, The embedded content includes at least one embedded content item available from at least one content server remote from the data processing system. The operations further including obtaining embedded content information from a source of the presentation content on the data processing system. The embedded content information identifies the at least one embedded content item and a source information for each respective embedded content item indicating the content server from which the respective embedded content item may be obtained. The operation also include causing the presentation content and the embedded content information to be sent to the plurality of computing devices of the participants to the online communication session, and causing the presentation content and a representation of each respective embedded content item of the embedded content information and a control associated with each respective embedded content item to be displayed on the plurality of computing devices of the participants. The control associated with a respective embedded content item, when activated, causes a respective computing device on which the control was activated to obtain the respective embedded content item from the source and present the respective content item on the respective computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIG. 2 is an example implementation of the presentation and communications platform shown in FIG. 1.

FIG. 3 is a diagram showing examples of data streams and other data exchanged between the presentation and communications platform and the client devices.

FIGS. 4A, 4B, and 4C are flow diagrams of additional processes that may be implemented by the presentation and communications platform and the client devices for extracting and sharing embedded content from presentation content.

FIGS. 5A, 5B, 5C, and 5D are flow diagrams of additional processes that may be implemented by the presentation and communications platform and the client devices for extracting and sharing embedded content from presentation content.

FIGS. 6A, 6B, 6C, and 6D are diagrams showing example user interfaces in which the techniques for identifying and sharing embedded content provided herein may be implemented.

FIGS. 7A, 7B, and 7C are diagrams showing example user interfaces in which the techniques for identifying and sharing embedded content provided herein may be implemented.

FIG. 8 is a flow diagram of an example process for identifying and sharing embedded content according to the techniques provided herein.

FIG. 9 is a block diagram showing an example software architecture, various portions of which may be used in conjunction with various hardware architectures herein described, which may implement any of the described features.

FIG. 10 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques provided herein provide a technical solution for solving the technical problem of sharing online content during an online meeting or other online communication session. These techniques include identifying and sharing embedded content included within presentation content of an online communication session. These techniques provide several approaches for identifying the embedded content included in the content of the computing device of a presenter, and for sharing embedded content information with the computing devices of participants to the online communication session. The embedded content information identifies the embedded content being shared by the presenter and a source from which the embedded content may be obtained by the computing devices of the participants to the computing devices. The embedded content information may be sent by the computing device of the presenter to the computing devices of the participants over a network connection or indirectly through an online communications platform facilitating the online communication session. The computing device of the presenter and/or the online communications platform may send a control signal to the computing devices of the participants to present information identifying the embedded content items on a user interface of the computing devices of the participants and display controls that enable participants to cause their respective computing devices to download and present the embedded content. Consequently, the user experience of the participants may be significantly improved by providing means for the participants to directly access and consume the embedded content on their respective computing devices. These and other technical benefits of the techniques disclosed herein will be evident from the discussion of the example implementations that follow.

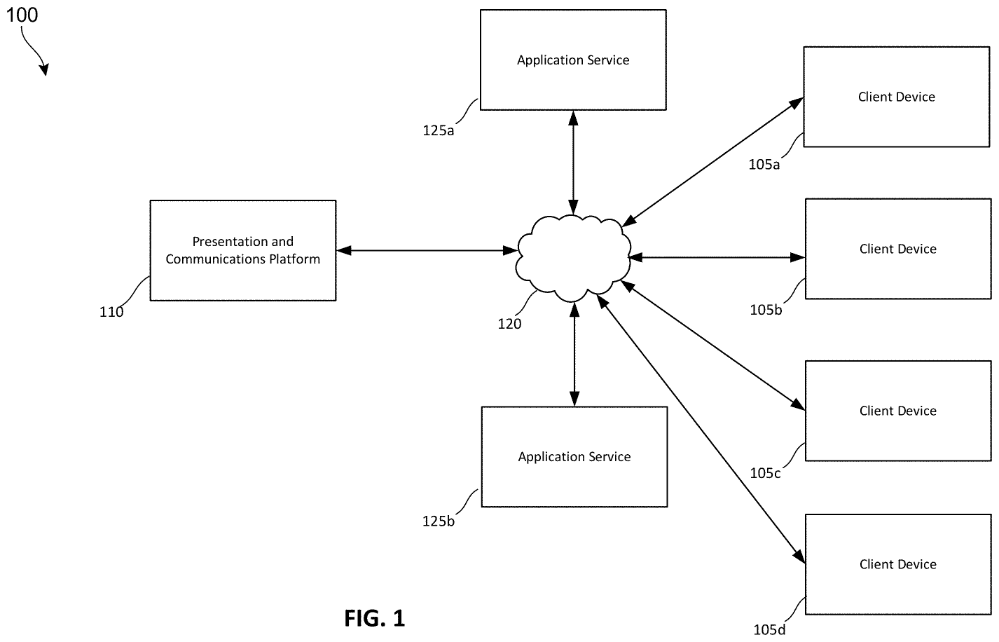

FIG. 1 is a diagram showing an example computing environment 100 in which the techniques disclosed herein for identifying and sharing a presentation that includes embedded content included presentation content of an online communication session may be implemented. The computing environment 100 may include a presentation and communications platform 110. The example computing environment 100 may also include one or more client devices, such as the client devices 105a, 105b, 105c, and 105d (collectively referred to as client device 105) and one or more application services, such as the application service 125a and 125b (collectively referred to as application service 125). The client devices 105a, 105b, 105c, and 105d may communicate with the presentation and communications platform 110 and/or the application services 125a and 125b via the network 120. The network 120 may be one or more public and/or private networks and may be implemented at least in part by the collective of public and private networks referred to as the Internet.

In the example shown in FIG. 1, the presentation and communications platform 110 may be implemented as a cloud-based service or set of services. The presentation and communications platform 110 may be configured to schedule and host online presentations, virtual meetings, video conferences, online collaboration sessions, and/or other online communications sessions in which at least a portion of the participants are located remotely from the presenter. The presentation and communications platform 110 provides services that enable the presenter to present content to remote participants and/or to facilitate a meeting that includes the remote participants. The presentation and communications platform 110 may also facilitate the identification of embedded content in a presentation and providing information to the client devices 105 of participants to obtain and present the embedded content on those devices rather than relying on a streamed version of the content from the client device 105 of the presenter.

The application services 125a and 125b may provide one or more cloud-based or network-based services for the computing devices 105a-105d. The application services 125a and 125b may provide a word processing application, a presentation application, project management software, a communications platform, a collaboration platform, a content sharing platform, and/or other services that are accessible to users via the computing devices 105a-105d and allow the users to communicate and/or consume, create, share, collaborate on, and/or modify content. Other types of services may be provided by the application services 125a and 125b in addition to or instead of these services. The services provided by the application services 125a and 125b may be accessed via a native application on a client device 105, via a native application configured to communicate with the application services 125a and 125b, via other means, or via a combination thereof.

The client devices 105a, 105b, 105c, and 105d are computing devices that may be implemented as a portable electronic device, such as a mobile phone, a tablet computer, a laptop computer, a portable digital assistant device, a portable game console, and/or other such devices. The client devices 105a-105d may also be implemented in computing devices having other form factors, such as a vehicle onboard computing system, a video game console, a desktop computer, and/or other types of computing devices. Each of the client devices 105a-105d may have different capabilities based on the hardware and/or software configuration of the respective client device. While the example implementation illustrated in FIG. 1 includes four client devices, other implementations may include a different number of client devices. Furthermore, the presentation and communications platform 110 is shown as being implemented as a service separate from the application services 125a and 125b. However, the presentation and communications platform 110 may be implemented as part of the same cloud-based set of services as one or more of the application services 125a and 125b.

In the example shown in FIG. 1, the presentation and communications platform 110 is shown as a cloud-based service that may be accessed over a network. However, other implementations of the presentation and communications platform 110 may be implemented by the application services 125a and 125b.

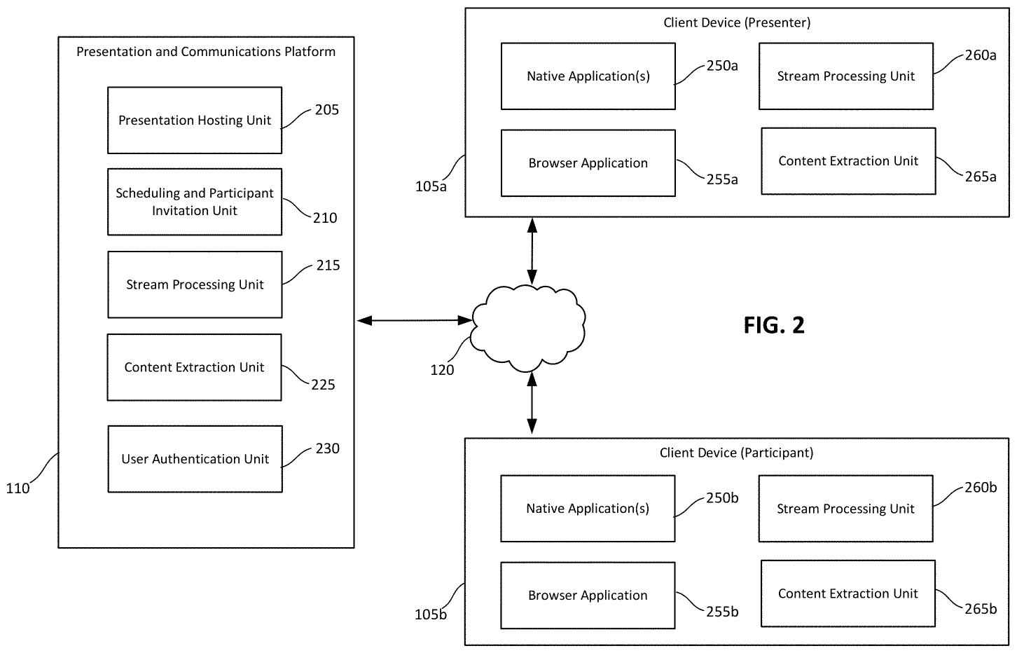

FIG. 2 is a diagram showing additional details of the presentation and communications platform 110 shown in FIG. 1. The presentation and communications platform 110 may include a presentation hosting unit 205, a scheduling and participant invitation unit 210, a stream processing unit 215, a content extraction unit 225, and an authentication unit 230. The client device 105a of the presenter may include a native application 250a, a browser application 255a, a stream processing unit 260a, and a content extraction unit 265a. The client device 105b of the participant may include a native application 250b, a browser application 255b, a stream processing unit 260b, and a content extraction unit 265b.

The presentation hosting unit 205 of the presentation and communications platform 110 may be configured to facilitate hosting of an online communication session. The online communication session may include presenter and one or more participants, and the presentation hosting unit 205 may facilitate sharing of presentation content by the presenter with the one or more participants. The scheduling and participant invitation unit 210 may be configured to provide means for users to schedule a meeting and to send invitations to participants. The authentication unit 230 may be configured to authenticate the presenter and/or participants to a communication session to ensure that a user is permitted to participate in and/or schedule communication sessions.

The presentation and communications platform 110 may also include a content extraction unit 225. The content extraction unit 225 may be configured to determine that presentation content of a presentation includes embedded content, to identify a source of the embedded content, and to provide embedded content information to the client devices 105 of the participants of a communication session. The examples which follow describe various means for determining that the presentation includes embedded content. The content extraction unit 225 may send a control signal to the client devices 105 of the participants of the communication session causing the presentation content and a representation of each respective embedded content item of the embedded content information and a control associated with each respective embedded content item to be displayed on a display of the client devices 105. When the control associated with a respective embedded content item is activated, the control causes the client device 105 on which the control was activated to obtain the respective embedded content item from the source and present the respective content item on the respective computing device.

The native applications 250a and 250b may be applications developed for use on the client device 105. Each client device 105 may include one or more native applications. The client device 105 may include a first native application may be a communications platform application configured to communicate with the presentation and communications platform 110 to facilitate scheduling of new communications sessions, participating in communication sessions, sharing presentation content during a communications session, and/or other features provided by the presentation and communications platform 110. The client device 105 may include one or more second native applications configured to communicate with the application services 125a and 125b to facilitate performing various features provided by the application services 125a and 125b. The one or more second applications may be a word processing application, a presentation application, project management application, a communications application, a collaboration platform application, a content sharing application, and/or other types of applications that may be provided by the application services 125a and 125b.

The browser applications 255a and 255b may be an application for accessing and viewing web-based content. The browser applications 255a and 255b may be the same application or may be different applications. In some implementations, the presentation and communications platform 110 may provide a web application for conducting and/or participating in an online presentation and/or communication session. The presenter or the participants may access the web application and render a user interface for interacting with the presentation and communications platform 110 in the browser applications 255a and 255b. In some implementations, the presentation and communications platform 110 may support both the native application 250a and 255b and the web application, and the presenter and participants may choose which approach best suites them for conducting and/or participating in an online presentation and/or communications session. Furthermore, in some implementations, the application service 125a and/or the application service 125b may provide a web application for accessing the application functionality provided by the application service.

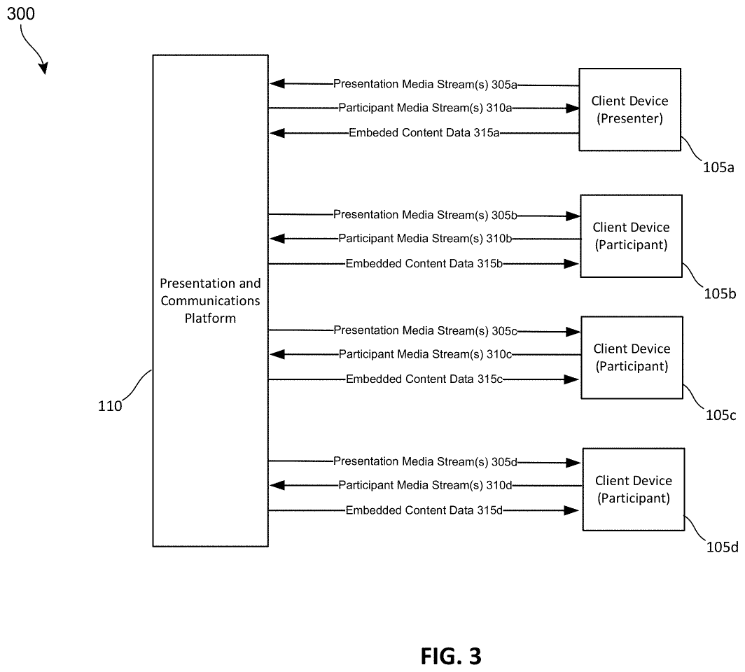

The client device 105a may also include a stream processing unit 260a, and the client device 105b may include a stream processing unit 260b, which may be configured to generate one or more media streams to be transmitted to the presentation and communications platform 110. The client device 105 of the presenter may also send embedded content information to the presentation and communications platform 110 and/or the client devices 105 of the participants of an online communication session. Some examples of the media streams and data that may be transmitted between the presentation and communications platform 110 and the client devices 105 are described in greater detail with respect to FIG. 3.

The client device 105a may include a content extraction unit 265a, and the client device 105b may include a content extraction unit 265b. The content extraction unit 265a may be configured to determine that the presenter is sharing presentation content during an online communication session and that the presentation content includes embedded content. The presenter may share the presentation content from a native application 250a or via the browser application 255a. Embedded content information may be obtained from the native application 250a or the browser application 255b as discussed in detail in the examples which follow. The embedded content information may be provided to the client devices 105 of the participants of the online communication session. In some implementations, the content extraction unit 265b of the client device may be configured to identify the embedded content in one or more media streams of the presentation content captured by the client device 105 of the presenter. An advantage of this solution is that embedded content may be automatically identified and extracted from presentation content without requiring the presenter to provide the embedded content information to the participants of the online communication session.

FIG. 3 is a diagram showing examples of data streams and other data exchanged between the presentation and communications platform 110 and the client devices 105a, 105b, 105c, and 105d. The presentation and communications platform 110 may transmit one or more presentation media streams 305 to each of the client devices 105 over the network 120. The one or more presentation media streams 305 may include one or more audio media streams, one or more video media streams, and/or other media streams. The one or more presentation media streams may include an audio component of the presentation in which the presenter is discussing presentation content being shared with the participants. The presentation content may include a set of slides, a document, or other content that may be discussed during presentation. As discussed in the preceding examples, the client device 105a of the presenter may transmit embedded content data 315a to the presentation and communications platform 110, and the presentation and communications platform 110 may transmit the embedded content data 315b, 315c, and 315d to the client devices 105b, 105c, and 105d of the participants. The embedded content data may include a control signal that causes the client device 105 receiving the embedded content information to present the embedded content information on a user interface of the client device 105.

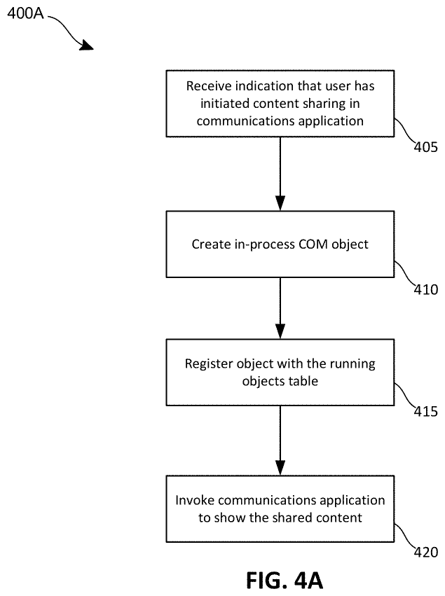

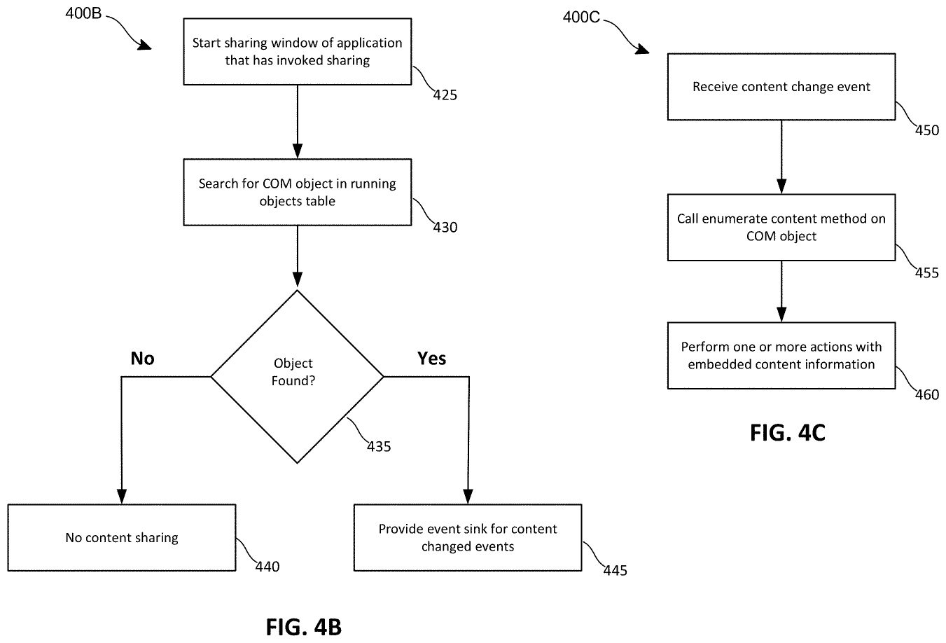

FIGS. 4A, 4B, and 4C are flow diagrams of additional processes 400A, 400B, and 400C that may be implemented by the presentation and communications platform and the client devices for extracting and sharing embedded content from presentation content. Processes 400A, 400B, and 400C provide one technical solution to the technical problem of sharing embedded content information for embedded content included in the presentation. In the examples shown in FIGS. 4A, 4B, and 4C, the presenter establishes a connection with a first native application 250a referred to as the hosting application, which is a communications platform application configured to communicate with the presentation and communications platform 110. Once the hosting application establishes the connection with the communication session, the user may initiate sharing of presentation content from a second native application 250a referred to as the sharing application, the sharing application may be a word processing application, a presentation application, project management application, a communications application, a collaboration platform application, a content sharing application, and/or other types of applications that may be provided by the application services 125a and 125b. An advantage of this solution is that the sharing application is configured to provide the embedded content information to the hosting application to facilitate sharing the embedded content information with the participants of the online communication session.

The process 400A may be implemented by the sharing application on which the presenter initiates sharing of presentation content. The process 400A may begin with an operation 405 of receiving an indication that the user has initiated content sharing in the communications application. The sharing may include a control that permits the user to initiate content sharing for an active online communication session. The user may click on or otherwise actuate the control to initiate the sharing process once the presentation content has been loaded by the sharing application.

The process 400A may include an operation 410 of creating a Component Object Model (COM) object. COM is a platform-independent, distributed, object-oriented system for creating binary software components. In other implementations, other types of objects may be used that facilitate inter-process communication. The process 400A may include an operation 415 of registering the COM object with a running objects table. The running object table is a globally accessible lookup table in memory of the client device 105a of the presenter. The COM object may be associated with a unique identifier for the sharing application. In an implementation that utilize the Microsoft Windows operating system, the COM object may be associated with a handle to a window (a “HWND”) of the sharing application.

The COM object may provide an object interface that may be queried by the hosting to obtain information regarding embedded content being shared by the sharing application. The COM object may provide a content change event. The content change event indicates that the content being shared by the sharing application. The presenter may have scrolled or otherwise navigated to a different portion of the presentation content being shared by the sharing application. The hosting application may listen for content change events indicating that the content being shared has changed.

The COM object interface may also provide an enumerate content method that allows the hosting application to obtain embedded content information for the presentation currently being shared by the sharing application. The enumerate content method may return a collection of objects that contain at least two fields: (1) a content type filed that represents a MIME type of the embedded content item (e.g., an image, video, or other content type) and (2) content uniform resource identifier (URI) identifying the source of the embedded content from which the embedded content item may be obtained by the client devices 105 of the participants to the online computing session. The sharing application may define the specific content types that may be included in the embedded content information. The content changed event signals the hosting application that the content provided by the sharing application has changed, and the hosting application calls the enumerate content method to obtain the current embedded content information.

The process 400A may include an operation 420 of invoking the hosting application to share the presentation content. The hosting application may generate one or more media streams, as shown in the preceding examples, that include the shared presentation content. The shared presentation content may include embedded content, and the sharing application may provide embedded content information for the embedded content to the hosting application via the COM object.

The process 400B may be implemented by the hosting application on which the presenter previously connected with the online communication session. The process 400B may begin with an operation 425 of start sharing the window of the sharing application in which the presentation content is being shown. The presentation contents shown in the window of the sharing application will be included in the presentation media streams 305a transmitted by the client device 105a of the presenter to the presentation and communications platform 110. The hosting application may then determine whether the presentation content includes embedded content.

The process 400B may include an operation 430 of searching for the COM object in the running objects table. The hosting application may look up the COM object using the HWND, or another identifier associated with the sharing application. The process 400B may include an operation 435 of determining whether the COM object has been found. The process 400B continues with operation 440 if the COM object is not found, and no embedded content information is shared with the client devices 105 of the participants. The presentation content, however, continues to be presented to the participants of the online communication session. Otherwise, if the COM object is found, the process 400B continues with an operation 445 in which the hosting application listens for content change events from the COM object indicating that the presentation contents being displayed by the sharing application has changed.

The process 400C may be implemented by the hosting application (the first native application 250a in this example implementation) once the hosting application has begun listening for the content change events. The process 400C may include an operation 450 of receiving a context change event. The hosting application may continue to listen for content change events from the COM object while the sharing application continues to share presentation content. The process 400C may include an operation 455 of calling the enumerate content method on the COM object to obtain a list of embedded content items. The process 400C may include an operation 460 of performing one or more actions on the embedded content information obtained from the COM object. In some implementations, the hosting application may send the embedded content information to the presentation and communications platform 110 and/or the client devices 105 of the participants to the online communication session. The hosting application may also send a control signal to the communications platform 110 and/or the client devices 105 of the participants to cause the computing devices of the client devices 105 to display a representation of the embedded content items identified in the embedded content information and to display a control or controls for accessing and consuming the embedded content items on the client devices 105.

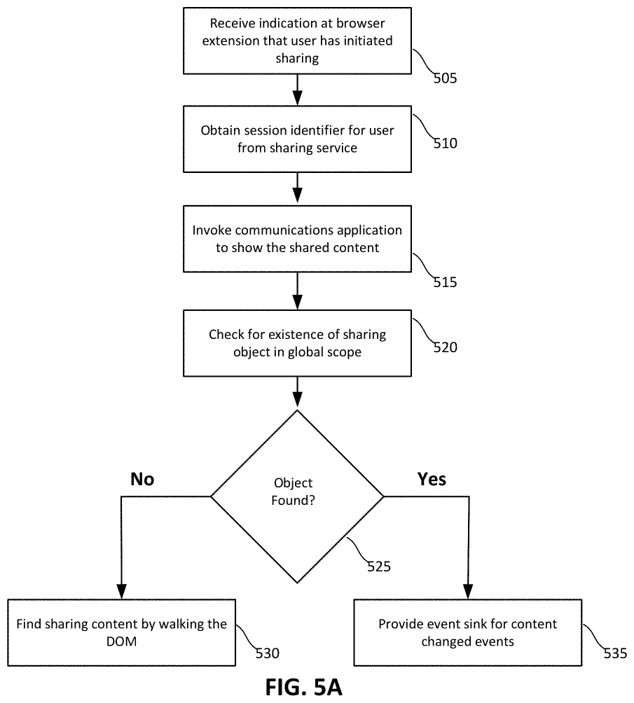

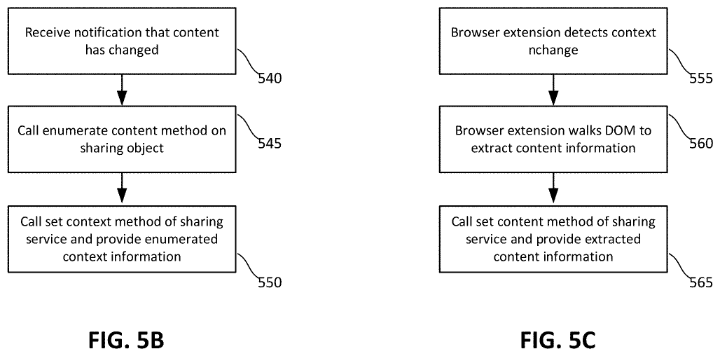

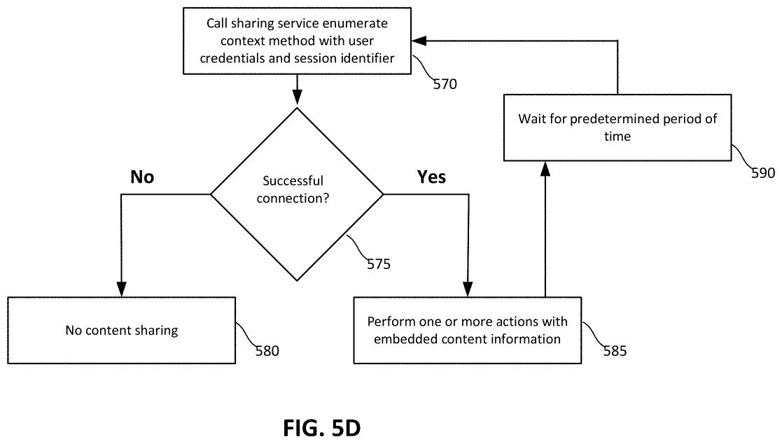

FIGS. 5A, 5B, 5C, and 5D are flow diagrams of additional processes 500A, 500B, 500C, and 500D that may be implemented by the presentation and communications platform and the client devices for extracting and sharing embedded content from presentation content. Processes 500A, 500B, 500C, and 500C provide one technical solution to the technical problem of sharing embedded content information for embedded content included in the presentation. provide another technical solution to the technical problem of sharing embedded content information for embedded content included in the presentation. In the example shown in FIGS. 5A, 5B, 5C, and 5D, content is shared using a sharing service and a browser extension rather than the COM object described in the preceding examples. In those examples, the sharing application may be the browser application 255a and the hosting application may be a native application 250a. An advantage of this solution is that the sharing application may be a web browser sharing any web content with the participants of the online communication session.

The process 500A may be implemented by a browser extension in the browser application 255a. The process 500A may include an operation 505 of receiving at the browser extension an indication that the user has initiating sharing of web content displayed in the browser application 255a. The web extension may include a control, which when activated, initiates sharing of the web content as the presentation content to be provided to the computing devices 105 of the participants of the online communication session. The web content may include embedded content as in the preceding examples.

The process 500A may include an operation 510 of obtaining a session identifier for the user from the sharing service. The web service facilitates communication between applications, for example the between the sharing application and the hosting application. The web service may create a new session in response to the browser extension providing an indication that the user has initiated sharing in the browser application 255a. The process 500A may include an operation 510 in which the web service creates a new session identifier for the user to share presentation content during the online communication session. The process 500A may include an operation 515 of invoking the hosting application to cause the hosting application to show the shared presentation content. The web service may invoke the hosting application and provide the session identifier to the hosting application. The process 500A may include an operation 520 in which the browser extension checks for the existence of a sharing object in the global scope of the browser application 255a. The browser application 255a may be configured to implement the sharing object, which may provide a similar interface as the COM object described in the preceding examples.

The process 500A may include an operation 525 of determining whether the sharing object was found. If the sharing object is not found, the process may continue with the operation 530 in which the browser object analyzes the document object model (DOM) of the web content being shared to identify any embedded content. If the sharing object is found, the process may continue with the operation 535 in which the browser extension may provide an event sink for content change events. The browser extension listens for content change events from the sharing object indicating that the web content being displayed by the browser application 255a has changed.

The process 500B may be implemented by the browser extension for implementation in which the sharing object is available. The process 500B may be implemented asynchronously by the browser extension upon completion of the process 500A. The process 500B may include an operation 540 of receiving a notification that the web content being shared in the browser application 255a has changed. The web content may include JavaScript or other means for firing a content changed event in response to the user navigation to a different portion of the web content. The process 500B may include an operation 540 of receiving a notification that the web content being shared in the browser application 255a has changed. The process 500B may include an operation 545 of calling the enumerate context method on the sharing object to obtain the list of embedded content items. The browser extension obtains the embedded content information from the sharing object so that the embedded content information may be provided to the hosting application. The process 500B may include an operation 550 of calling the set content method of the sharing service to provide the embedded content information to the sharing application.

The process 500C may be implemented by the browser extension for implementation in which the sharing object is unavailable and the browser extension extracts information from the DOM of the web content. The process 500C may be implemented asynchronously by the browser extension upon completion of the process 500A. The process 500B may include an operation 555 in which the browser extension detects a content change. The browser extension may detect that the user has navigated to a different section of the presentation content.

The process 500C may include an operation 560 in which the browser extension traverses the DOM of the web content to extract context information. The browser extension may identify video tags, image tags, audio tags, and/or other types of tags in the web content being displayed by browser application 255 and organize the extracted information as the embedded content information described in the preceding examples. The process 500C may include an operation 565 in which the browser extension calls the set content method of the ?sharing service to provide the extracted content information to the sharing service.

The process 500D may be implemented by the hosting application. The process 500D may be used by the hosting application to determine whether any changes have been made to the shared web content and obtain embedded content information.

The process 500D may include an operation 570 of calling the enumerate content method of the sharing service. The sharing service may provide an enumerate content method similar to the COM object, which provides embedded content information for the presentation currently being shared by the sharing application. The process 500D may provide the sharing service with user credentials for the presenter and the session identifier. The sharing service may determine whether the user credentials match those of the presenter and that the session identifier matches that of the session established by browser application 255a. If either of these parameters does not match the expected values, then request for the embedded content information fails. Otherwise, the hosting application obtains the embedded content information from the sharing service.

The process 500D may include an operation 575 of determining whether the operation 570 was successful. If the operation was unsuccessful, the process 500D may continue with an operation 580 in which the sharing application is unable to access embedded content information. The web content shared by the browser application may still be provided as the presentation content to the client devices 105 of the participants of the communication session, but no embedded content information will be provided to the client devices 105 of the participants. However, the client devices 105 of the participants may be configured to perform optical character recognition (OCR) analysis of the content included in the presentation media stream(s) 305.

If the operation 570 was successful, the process 500D may continue with an operation 585 of performing one or more actions on the embedded content information obtained from the COM object. In some implementations, the hosting application may send the embedded content information to the presentation and communications platform 110 and/or the client devices 105 of the participants to the online communication session. The hosting application may also send a control signal to the communications platform 110 and/or the client devices 105 of the participants to cause the computing devices of the client devices 105 to display a representation of the embedded content items identified in the embedded content information and to display a control or controls for accessing and consuming the embedded content items on the client devices 105. The process may continue with an operation 590 in which the hosting application waits for a predetermined period of time before proceeding to operation 570. The predetermined period may be selected based to determine a frequency at which the hosting application should check for changes in the shared web content.

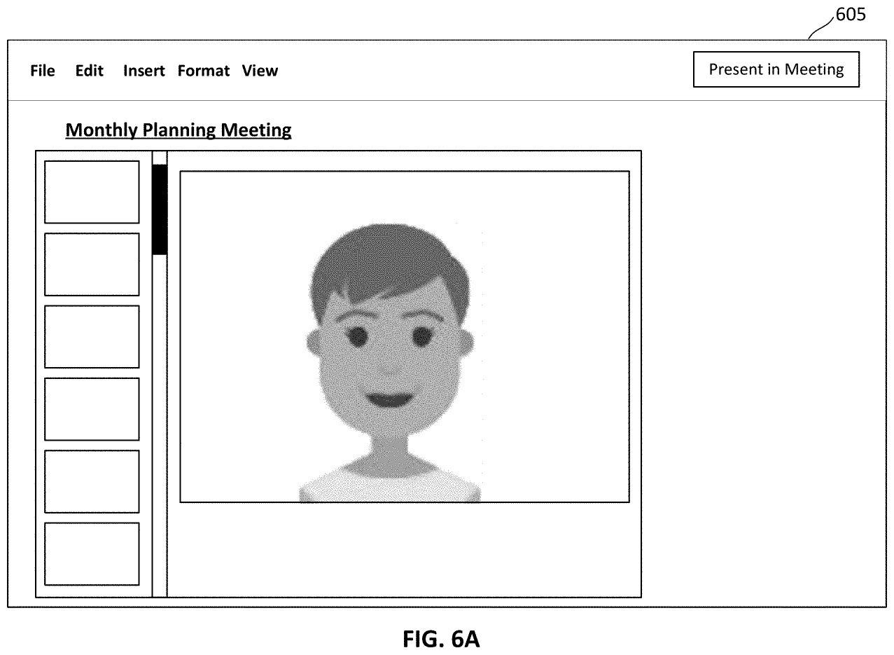

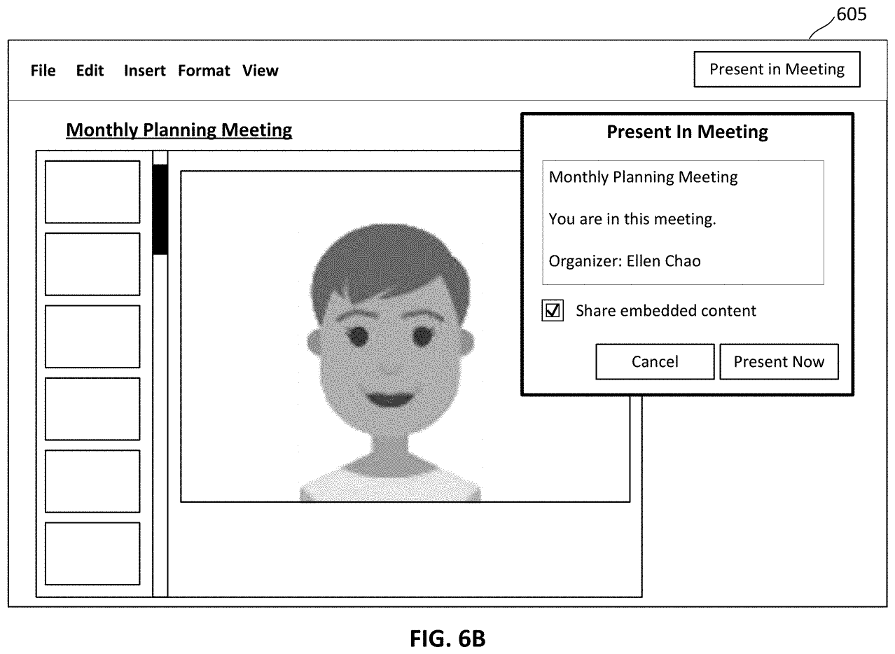

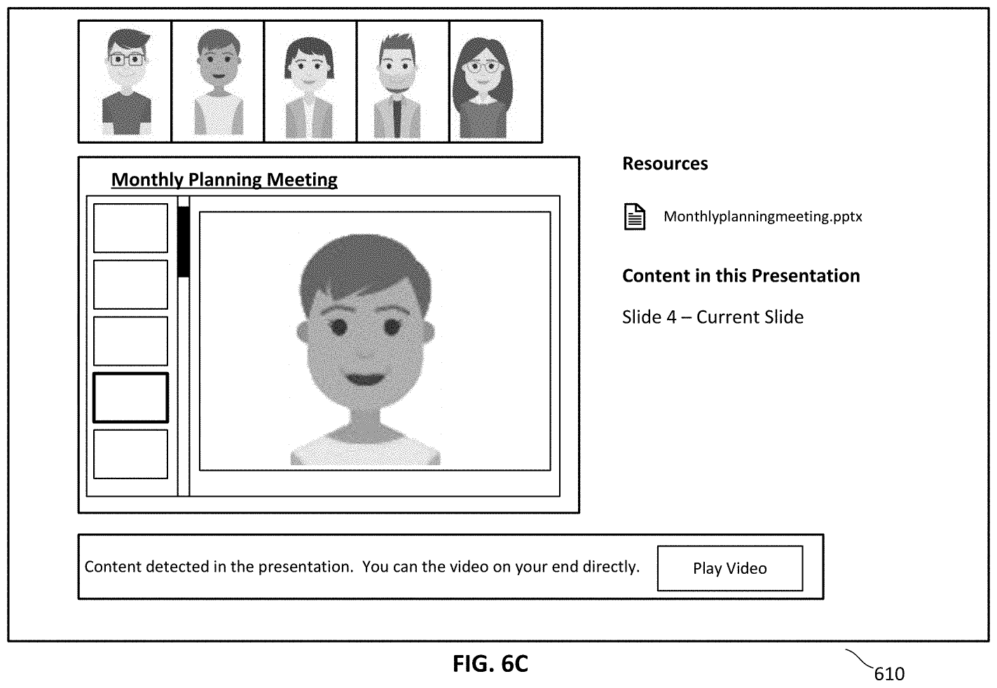

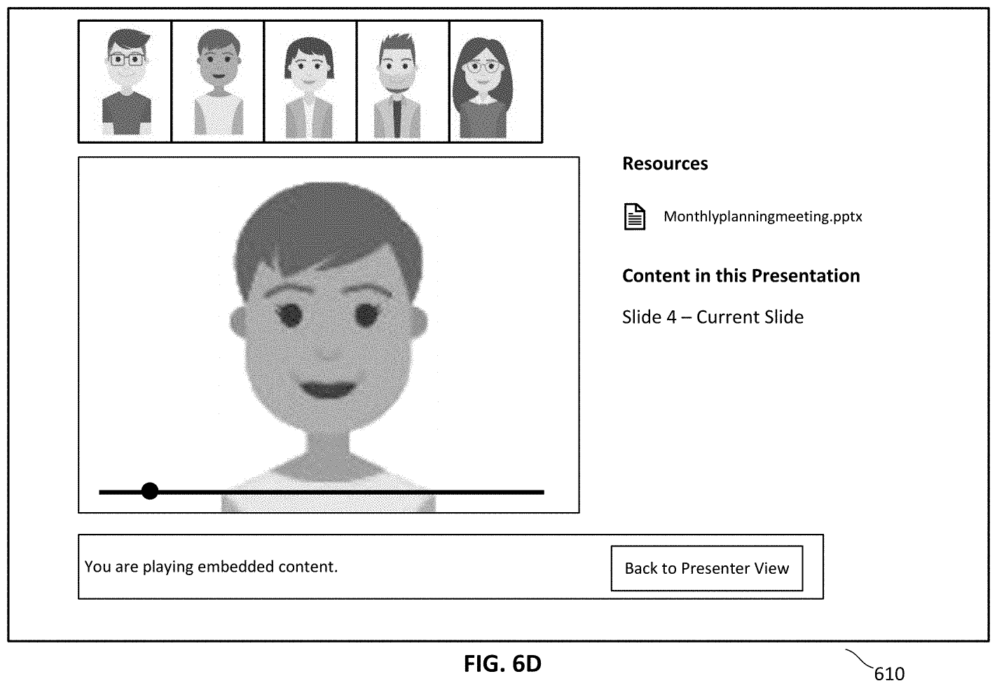

FIGS. 6A, 6B, 6C, and 6D are diagrams showing example user interfaces 605 and 610 in which the techniques for identifying and sharing embedded content provided herein may be implemented. The user interface 605 is an example user interface of a presentation application that may implement the embedded content sharing techniques discussed in the preceding examples. The user interface 605 may be displayed on the client device 105a of the presenter. The user interface 605 may include a “present in meeting” button that, when activated, causes the user interface 605 to display a popup dialog in which information regarding an ongoing online communication session being hosted by the hosting application in which the content presented from the sharing application will be provided to the client devices 105 of the participants to the online communication session. The dialog may include an option for enabling or disabling the sharing of embedded content information. If the user disables the sharing of embedded content information, the client device 105 of the presenter will not provide embedded content information to the presentation and communications platform 110 and/or the client devices 105 of the participants of the communication session.

The user interface 610 shows an example user interface that may be presented on the display of the client devices 105 of the participants. The user interface 610 may present a message that embedded content has been detected in the presentation and provide a control that allows the participant to download the embedded content to their client device 105. The user interface 610 may also provide a list of the embedded content in the presentation. The user may select any of the embedded content items from the list and cause the item to be downloaded and/or displayed by the client device 105. FIG. 6D shows an example of the user interface 610 in which a content item is being presented to the participant after being downloaded to the client device 105 of the participant. The user interface 610 may provide a control that allows the user to return to the presenter view. The presenter view represents content currently being shared by the presenter.

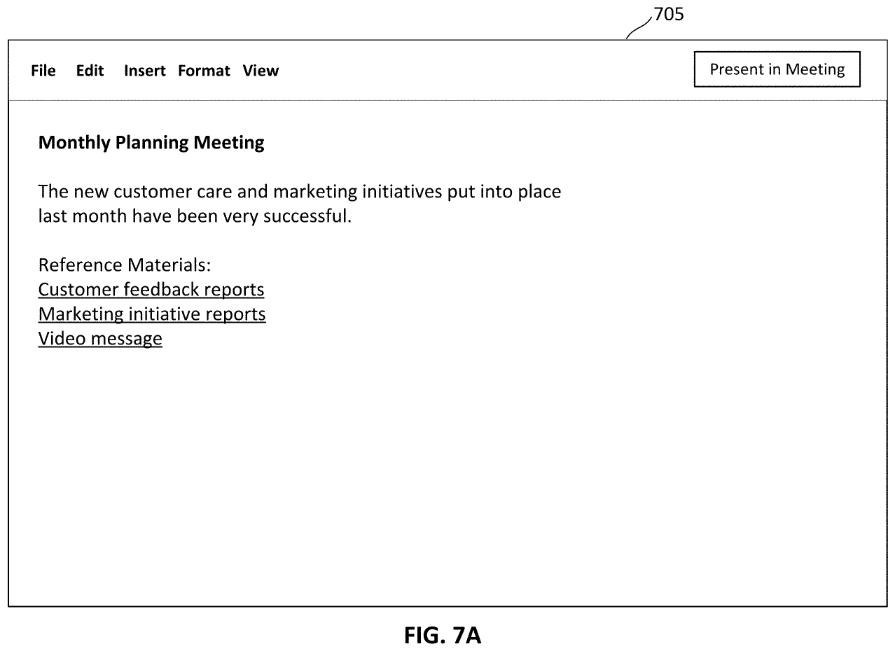

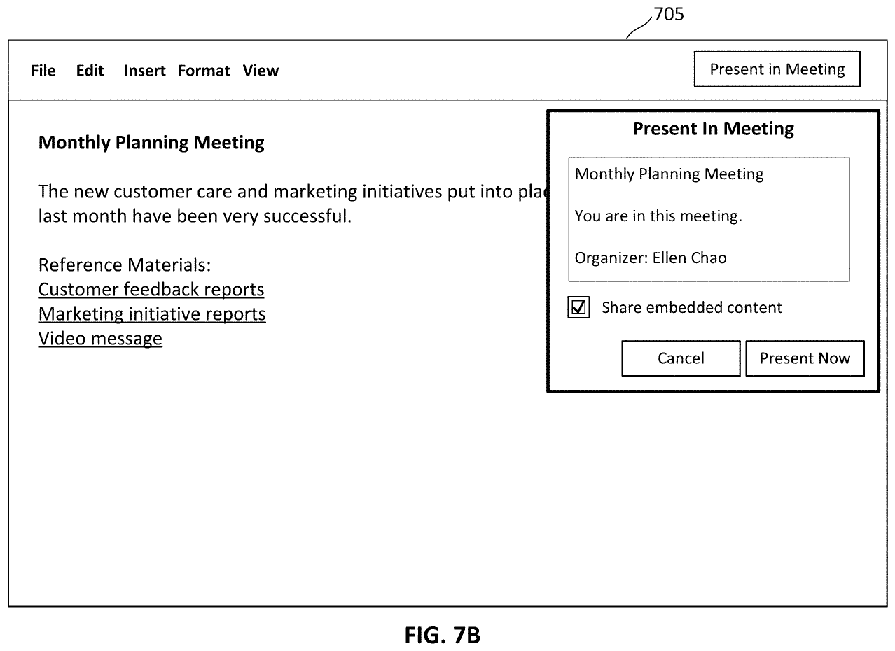

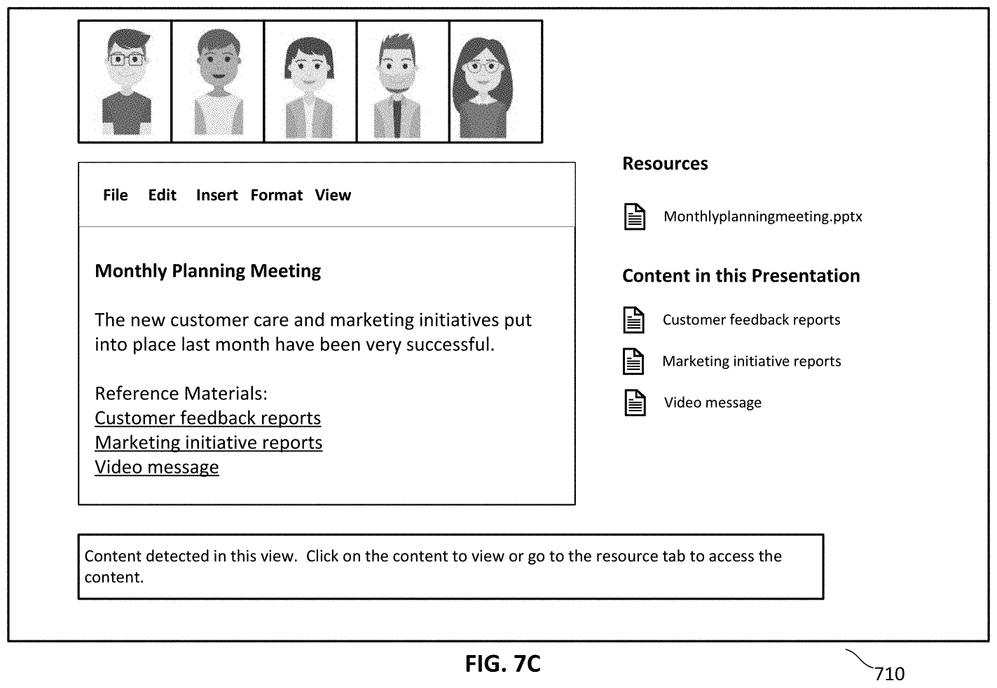

FIGS. 7A, 7B, and 7C are diagrams showing example user interfaces 705 and 710 in which the techniques for identifying and sharing embedded content provided herein may be implemented. The user interface 705 is an example user interface of a browser application that may implement the embedded content sharing techniques discussed in the preceding examples. The user is sharing content that includes three hyperlinks to embedded content items. The user interface 705 may be displayed on the client device 105a of the presenter. The user interface 705 may include a “present in meeting” button that, when activated, causes the user interface 705 to display a popup dialog similar to that shown in the user interface 605.

The user interface 710 is an example user interface that may be presented on the display of the client devices 105 of the participants. The user interface 710 may present a message that embedded content has been detected in the presentation and provide a control that allows the participant to download the embedded content to their client device 105. The user interface 710 may also provide a list of the embedded content in the presentation. The user may select any of the embedded content items from the list and cause the item to be downloaded and/or displayed by the client device 105. The user may also click on or otherwise the hyperlinks in the representation of the presentation content to cause the client device 105 to download and/or display the selected content.

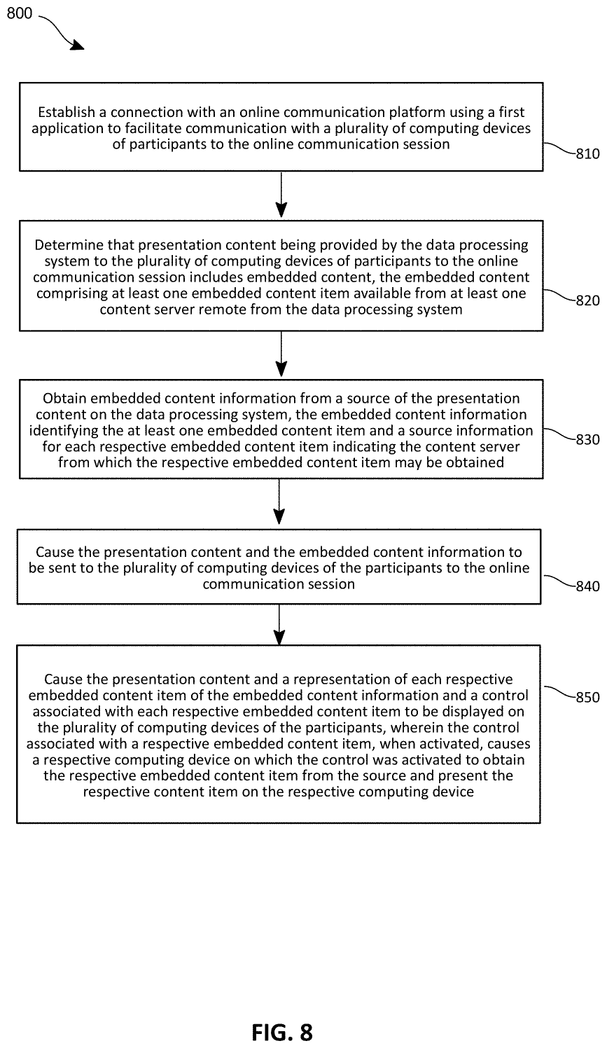

FIG. 8 is a flow chart of an example process 800 for sharing content in an online communication session. The process 800 may be implemented by the content extraction unit 265a of the client device 105a of the presenter. In other implementations, the process 800 may be implemented by the presentation and communications platform 110.

The process 800 may include an operation 810 of establishing a connection with an online communication platform using a first application to facilitate communication with a plurality of computing devices 105 of participants to an online communication session. The hosting application may establish the online communication session with the presentation and communications platform 110.

The process 800 may include an operation 820 of determining that presentation content being provided by the data processing system to the plurality of computing devices of participants to the online communication session includes embedded content. The embedded content includes at least one embedded content item available from at least one content server remote from the data processing system. The embedded content may be available from a content server that is removed from the presentation and communications platform 110. The presenter may present content that includes one or more such embedded content items that may be more efficiently consumed by the participants on the computing devices 105 of the participants.

The process 800 may include an operation 830 of obtaining embedded content information from a source of the presentation content on the data processing system. The embedded content information identifies at least one embedded content item and source information for each respective embedded content item indicating the content server from which the respective embedded content item may be obtained. The embedded content information may be obtained by the hosting application using the various techniques described in the preceding examples.

The process 800 may include an operation 840 of causing the presentation content and the embedded content information to be sent to the plurality of computing devices of the participants to the online communication session. The presentation content may be transmitted to the presentation and communications platform 110 in one or more presentation media streams 305a and the embedded content data 315a.

The process 800 may include an operation 850 of causing the presentation content and a representation of each respective embedded content item of the embedded content information and a control associated with each respective embedded content item to be displayed on the plurality of computing devices of the participants. The control associated with a respective embedded content item, when activated, causes a respective computing device on which the control was activated to obtain the respective embedded content item from the source and present the respective content item on the respective computing device.

The detailed examples of systems, devices, and techniques described in connection with FIGS. 1-8 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-8 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

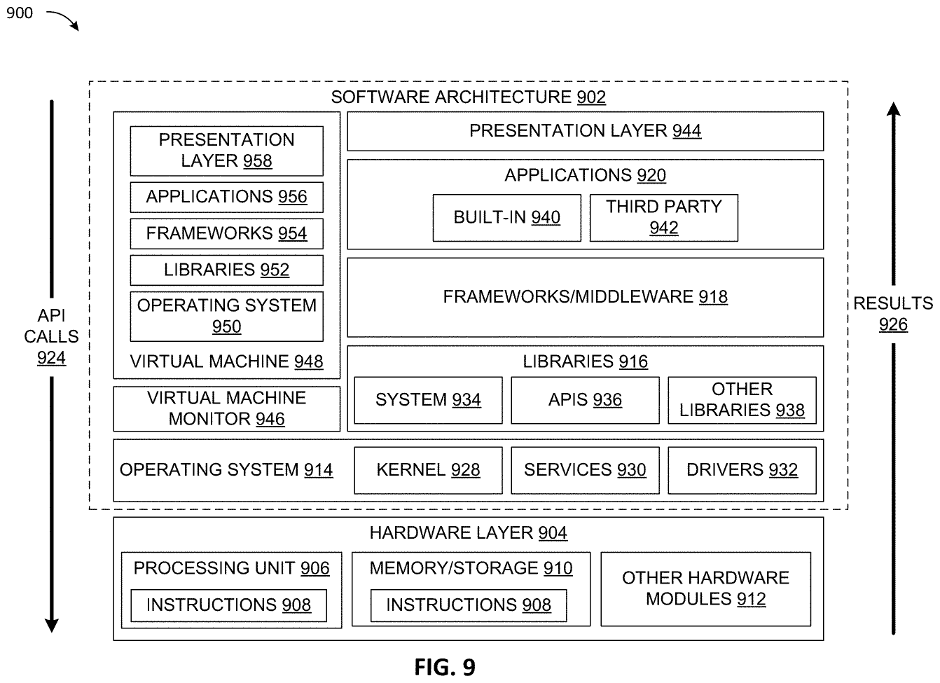

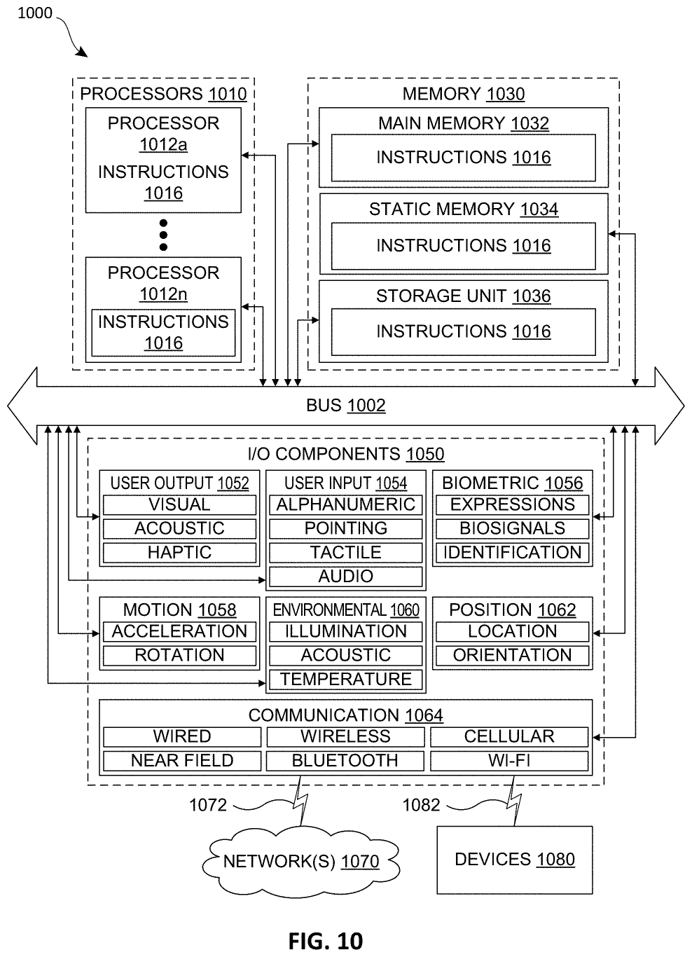

FIG. 9 is a block diagram 900 illustrating an example software architecture 902, various portions of which may be used in conjunction with various hardware architectures herein described, which may implement any of the above-described features. FIG. 9 is a non-limiting example of a software architecture, and it will be appreciated that many other architectures may be implemented to facilitate the functionality described herein. The software architecture 902 may execute on hardware such as a machine 1000 of FIG. 10 that includes, among other things, processors 1010, memory 1030, and input/output (I/O) components 1050. A representative hardware layer 904 is illustrated and can represent, for example, the machine 1000 of FIG. 10. The representative hardware layer 904 includes a processing unit 906 and associated executable instructions 908. The executable instructions 908 represent executable instructions of the software architecture 902, including implementation of the methods, modules and so forth described herein. The hardware layer 904 also includes a memory/storage 910, which also includes the executable instructions 908 and accompanying data. The hardware layer 904 may also include other hardware modules 912. Instructions 908 held by processing unit 906 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks 918, applications 920, and a presentation layer 944. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 938 to provide many functions for applications 920 and other software modules.

The frameworks 918 (also sometimes referred to as middleware) provide a higher-level common infrastructure that may be used by the applications 920 and/or other software modules. For example, the frameworks 918 may provide various graphic user interface (GUI) functions, high-level resource management, or high-level location services. The frameworks 918 may provide a broad spectrum of other APIs 936 for applications 920 and/or other software modules.

The applications 920 include built-in applications 940 and/or third-party applications 942. Examples of built-in applications 940 may include, but are not limited to, a contacts application, a browser application, a location application, a media application, a messaging application, and/or a game application. Third-party applications 942 may include any applications developed by an entity other than the vendor of the particular platform. The applications 920 may use functions available via OS 914, libraries 916, frameworks 918, and presentation layer 944 to create user interfaces to interact with users.

Some software architectures use virtual machines, as illustrated by a virtual machine 948. The virtual machine 948 provides an execution environment where applications/modules can execute as if they were executing on a hardware machine (such as the machine 1000 of FIG. 10, for example). The virtual machine 948 may be hosted by a host OS (for example, OS 914) or hypervisor, and may have a virtual machine monitor 946 which manages operation of the virtual machine 948 and interoperation with the host operating system. A software architecture, which may be different from software architecture 902 outside of the virtual machine, executes within the virtual machine 948 such as an OS 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement modules or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” includes a collection of machines that individually or jointly execute the instructions 1016.

The machine 1000 may include processors 1010, memory 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multi-core processor including cores that may execute instructions contemporaneously. Although FIG. 10 shows multiple processors, the machine 1000 may include a single processor with a single core, a single processor with multiple cores (for example, a multi-core processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056, motion components 1058, environmental components 1060, and/or position components 1062, among a wide array of other physical sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1058 may include, for example, acceleration sensors (for example, an accelerometer) and rotation sensors (for example, a gyroscope). The environmental components 1060 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 1064 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1062, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable medium storing executable instructions that, when executed, cause the processor to perform operations comprising:
establishing a connection with an online communication platform using a first application to facilitate communication with a plurality of computing devices of participants to an online communication session;
determining that presentation content being provided by the data processing system to the plurality of computing devices of participants to the online communication session includes embedded content, the embedded content comprising at least one embedded content item available from at least one content server remote from the data processing system;
obtaining embedded content information from a source of the presentation content on the data processing system, the embedded content information identifying the at least one embedded content item and a source information for each respective embedded content item indicating the content server from which the respective embedded content item may be obtained;
causing the presentation content and the embedded content information to be sent to the plurality of computing devices of the participants to the online communication session; and
causing the presentation content and a representation of each respective embedded content item of the embedded content information and a control associated with each respective embedded content item to be displayed on the plurality of computing devices of the participants,
wherein the control associated with a respective embedded content item, when activated, causes a respective computing device on which the control was activated to obtain the respective embedded content item from the source and present the respective content item on the respective computing device.

2. The data processing system of claim 1, wherein determining that the presentation content includes embedded content further comprises:
receiving, at a first application on the data processing system, a first indication from a second application on the data processing system that the presentation content is being shared from the second application; and
obtaining, at the first application, a second indication from the second application that the presentation content includes the embedded content.

3. The data processing system of claim 2, wherein the second application is the source of the presentation content, wherein obtaining the embedded content information further comprises:
requesting the embedded content information from the second application using a request embedded content method of an application programming interface (API) implemented by the second application; and
receiving the embedded content information from second application via the API in response to requesting the embedded content information.

4. The data processing system of claim 3, wherein the machine-readable medium further comprises instructions configured to cause the processor to perform operations of:
listening for change events from the second application indicating that the presentation content being shared has changed; and
requesting updated embedded content information from the second application using the request embedded content method of the API implemented by the second application.

5. The data processing system of claim 2, wherein the second application is a browser application, wherein the presentation content is a webpage, and wherein obtaining the embedded content information further comprises:
obtaining a content sharing object;
listening for change events from the content sharing object indicating that the webpage being shared has changed; and
requesting the embedded content information from the second application using a request embedded content method of the content sharing object.

6. The data processing system of claim 5, wherein the machine-readable medium further comprises instructions configured to cause the processor to perform operations of:
providing the embedded content information to a web service associated with the first application; and
periodically polling the web service from the first application to obtain the embedded content information.

7. The data processing system of claim 6, wherein the machine-readable medium further comprises instructions configured to cause the processor to perform operations of:
determining that the content sharing object is unavailable; and
analyzing a document object model (DOM) of the webpage to extract links associated with embedded content items as the embedded content information.

8. A method implemented in a data processing system for sharing content in an online communication session, the method comprising:
establishing a connection with an online communication platform using a first application to facilitate communication with a plurality of computing devices of participants to the online communication session;
determining that presentation content being provided by the data processing system to the plurality of computing devices of participants to the online communication session includes embedded content, the embedded content comprising at least one embedded content item available from at least one content server remote from the data processing system;
obtaining embedded content information from a source of the presentation content on the data processing system, the embedded content information identifying the at least one embedded content item and a source information for each respective embedded content item indicating the content server from which the respective embedded content item may be obtained;
causing the presentation content and the embedded content information to be sent to the plurality of computing devices of the participants to the online communication session; and
causing the presentation content and a representation of each respective embedded content item of the embedded content information and a control associated with each respective embedded content item to be displayed on the plurality of computing devices of the participants,
wherein the control associated with a respective embedded content item, when activated, causes a respective computing device on which the control was activated to obtain the respective embedded content item from the source and present the respective content item on the respective computing device.

9. The method of claim 8, wherein determining that the presentation content includes embedded content further comprises:
receiving, at a first application on the data processing system, a first indication from a second application on the data processing system that the presentation content is being shared from the second application; and
obtaining, at the first application, a second indication from the second application that the presentation content includes the embedded content.

10. The method of claim 9, wherein the second application is the source of the presentation content, wherein obtaining the embedded content information further comprises:
requesting the embedded content information from the second application using a request embedded content method of an application programming interface (API) implemented by the second application; and
receiving the embedded content information from second application via the API in response to requesting the embedded content information.

11. The method of claim 10, further comprising:
listening for change events from the second application indicating that the presentation content being shared has changed; and
requesting updated embedded content information from the second application using the request embedded content method of the API implemented by the second application.

12. The method of claim 9, wherein the second application is a browser application, wherein the presentation content is a webpage, and wherein obtaining the embedded content information further comprises:
obtaining a content sharing object;
listening for change events from the content sharing object indicating that the webpage being shared has changed; and
requesting the embedded content information from the second application using a request embedded content method of the content sharing object.

13. The method of claim 12, further comprising:
providing the embedded content information to a web service associated with the first application; and
periodically polling the web service from the first application to obtain the embedded content information.

14. The method of claim 13, further comprising:
determining that the content sharing object is unavailable; and
analyzing a document object model (DOM) of the webpage to extract links associated with embedded content items as the embedded content information.

15. A machine-readable medium on which are stored instructions that, when executed, cause a processor of a programmable device to perform operations of:
establishing a connection with an online communication platform using a first application to facilitate communication with a plurality of computing devices of participants to an online communication session;
determining that presentation content being provided by the data processing system to the plurality of computing devices of participants to the online communication session includes embedded content, the embedded content comprising at least one embedded content item available from at least one content server remote from the data processing system;
obtaining embedded content information from a source of the presentation content on the data processing system, the embedded content information identifying the at least one embedded content item and a source information for each respective embedded content item indicating the content server from which the respective embedded content item may be obtained;
causing the presentation content and the embedded content information to be sent to the plurality of computing devices of the participants to the online communication session; and
causing the presentation content and a representation of each respective embedded content item of the embedded content information and a control associated with each respective embedded content item to be displayed on the plurality of computing devices of the participants,
wherein the control associated with a respective embedded content item, when activated, causes a respective computing device on which the control was activated to obtain the respective embedded content item from the source and present the respective content item on the respective computing device.

16. The machine-readable medium of claim 15, wherein determining that the presentation content includes embedded content further comprises:
receiving, at a first application on the data processing system, a first indication from a second application on the data processing system that the presentation content is being shared from the second application; and
obtaining, at the first application, a second indication from the second application that the presentation content includes the embedded content.

17. The machine-readable medium of claim 16, wherein the second application is the source of the presentation content, wherein obtaining the embedded content information further comprises:
requesting the embedded content information from the second application using a request embedded content method of an application programming interface (API) implemented by the second application; and
receiving the embedded content information from the second application via the API in response to requesting the embedded content information.

18. The machine-readable medium of claim 17, further comprising instructions configured to cause the processor to perform operations of:
listening for change events from the second application indicating that the presentation content being shared has changed; and
requesting updated embedded content information from the second application using the request embedded content method of the API implemented by the second application.

19. The machine-readable medium of claim 16, wherein the second application is a browser application, wherein the presentation content is a webpage, and wherein obtaining the embedded content information further comprises:
obtaining a content sharing object;
listening for change events from the content sharing object indicating that the webpage being shared has changed; and
requesting the embedded content information from the second application using a request embedded content method of the content sharing object.

20. The machine-readable medium of claim 19, further comprising instructions configured to cause the processor to perform operations of:
providing the embedded content information to a web service associated with the first application; and
periodically polling the web service from the first application to obtain the embedded content information.
